(19) United States
(12) Patent Application Publication
(10) Pub. No.: US 2026/0091692 A1
(43) Pub. Date: Apr. 2, 2026

(54) YARD SWITCHERS LOCOMOTIVES ZERO EMISSION OPERATION

(71) Applicant: VOLTIFY INC., Philadelphia, PA (US)

(72) Inventor: Alon KESSEL, Ramat-Gan (IL)

(21) Appl. No.: 18/901,358

(22) Filed: Sep. 30, 2024

(51) Int. Cl. B60L 50/53

(52) U.S. Cl. CPC B60L 50/53; B60L 2200/26

(57) ABSTRACT

The present invention discloses a zero-emission operating methods, kit and systems for charging a battery locomotive while the battery locomotive is passing through a charging infrastructure, while optimizing the energy cost. In addition, a method for retrofitting a diesel locomotive to a battery locomotive and system thereof is disclosed.

### FIELD OF THE INVENTION

The present invention is in the field of a system and method for yard switchers (shunt) locomotives zero emission operation.

### BACKGROUND OF THE INVENTION

The field of yard switcher locomotives has traditionally relied on diesel-powered engines, which present numerous challenges, including air pollution, noise pollution, and high operational costs. Diesel engines contribute significantly to greenhouse gas emissions and require extensive maintenance due to their mechanical complexity and fuel combustion processes. This has necessitated a shift towards more sustainable and economical alternatives to meet both environmental regulations and operational efficiencies. Battery-electric locomotives offer a promising solution by providing zero-emission operations and lower long-term maintenance requirements.

Existing battery-electric locomotives, however, face several technical and practical limitations. One major challenge is the energy storage capacity and the need for efficient charge and discharge cycles to meet the operational demands of yard activities. Furthermore, integrating electric motors with existing locomotive drive trains requires extensive retrofitting, which can be time-consuming and costly.

An additional consideration is the energy infrastructure needed for sustained battery-electric operation. Current charging systems often require lengthy stationary periods, which reduce operational uptime. The integration of renewable energy sources into yard operations is also constrained by their variability, such as inconsistent solar power generation. Effective energy storage systems must accommodate these fluctuations to ensure a continuous and reliable power supply for charging locomotives. Prior art lacks a fully integrated system for optimizing both energy generation and storage to minimize operational costs and ensure a reliable supply.

The main drawback of the current battery locomotive yard operation is the operational downtime required for charging. The charging rate is limited due to the energy storage charging rate characteristic and the power supply limitation from the yard grid power connection scale.

A new solution is needed to enhance zero emission yard switching operation. Such a system would integrate operational efficiency enabling no down time for charging and high energy cost efficiency, due to energy management optimization. Additionally, microgrid systems that utilize second-life EV batteries could support the inclusion of renewable energy sources, mitigating their variability and promoting sustainability. Enhanced sensor technology, including radar and ultrasonic systems, could further aid in lower shocks affecting the locomotive energy storage system on board. Finally, an advanced energy optimization model employing Mixed-Integer Linear Programming (MILP) would ensure cost-effective and reliable energy provision, leveraging both CAPEX (capital expenditures) and OPEX (operational expenditures) considerations to achieve the lowest levelized cost of energy for yard operations.

### SUMMARY OF THE INVENTION

It is hence an object of the invention to disclose a zero-emission operating system for charging a locomotive comprising a locomotive; a yard microgrid having an at least one power source and an energy storage system (ESS); a charging infrastructure configured to charge a battery locomotive; and an energy optimization system configured when executed to manage and optimize energy supply to the battery locomotive.

In some embodiments, the ESS is in electrical communication with the at least one power source.

In some embodiments, the charging infrastructure in electrical communication with the yard microgrid.

In some embodiments, the battery locomotive comprises an at least pantograph.

In some embodiments, the charging infrastructure comprises an at least one conductor.

In some embodiments, operation of the battery locomotive has zero charging down time and zero labor cost involve in charging.

In some embodiments, the conductor comprises an overhead conductor, a third rail conductor, and any combination thereof.

In some embodiments, charging is selected from the group consisting of regenerating charging, unmanned dynamic or static charging, including any combination thereof.

In some embodiments, energy storage system of the battery locomotive comprises electrical energy at any given time.

In some embodiments, the microgrid ESS is configured to provide a buffer for rapid and high-capacity charging availability.

In some embodiments, the energy optimization comprises an optimization model for minimizing the levelized cost of energy (LCOE) for yard operations; a mixed integer linear programming (MILP) formulation for evaluating multiple configurations of yard energy usage; and wherein the energy optimization is configured to yield the lowest LCOE while taking in consideration variability of renewable energy sources.

It is hence another object of the invention to disclose a locomotive retrofitting system comprising a battery configured to replace an existing fuel source of a locomotive; an electric traction motor configured to replace an existing diesel engine; an at least one pantograph; a direct current-direct current converter; a direct current chamber; and a battery chamber; and wherein the retrofit system is configured to ensure compatibility and optimized performance for battery operation.

In some embodiments, the locomotive retrofit system further comprising a damper configured to protect the battery pack from vibrations and shocks.

In some embodiments, the locomotive retrofit system further comprising an at least one radar system configured to aid in reducing locomotive coupling shocks apply on the energy storage system.

In some embodiments, charging of the retrofitted diesel locomotive is selected from the group consisting of regenerating charging, unmanned dynamic or unmanned static charging, including any combination thereof.

In some embodiments, operation of the retrofitted diesel locomotive has zero charging down time and zero labor cost involve in charging.

It is hence another object of the invention to disclose a method for retrofitting a diesel yard to a battery yard comprising retrofitting a diesel locomotive to a battery locomotive; adding a charging infrastructure; and building a renewable energy source.

In some embodiments, the retrofitting the diesel locomotive comprise: replacing an existing fuel source of the diesel locomotive with a battery. Replacing a diesel engine with an electric traction and adding to the diesel locomotive, an at least one pantograph, a direct current-direct current converter, a battery chamber, and a direct current chamber.

In some embodiments, the retrofitted diesel locomotive is for use in a zero-emission operating system.

In some embodiments, the charging infrastructure comprises of at least one conductor.

In some embodiments, operation of the retrofitted diesel locomotive has zero charging down time and zero labor cost involve in charging.

In some embodiments, charging of the retrofitted diesel locomotive is selected from the group consisting of regenerating charging, unmanned dynamic or unmanned static charging, including any combination thereof.

It is hence another object of the invention to disclose a locomotive retrofitting kit comprising: a battery configured to replace an existing fuel source of a locomotive; an electric traction motor configured to replace an existing diesel engine; an at least one pantograph; a direct current-direct current converter; a direct current chamber; a battery chamber; and a compressor, wherein the retrofit kit is configured to ensure compatibility with a locomotive to be retrofitted and configured for optimized performance for battery operation.

In some embodiments, the locomotive retrofit kit further comprising a damper configured to protect the battery pack from vibrations and shocks.

In some embodiments, further comprising an at least one radar system configured to aid in reducing locomotive coupling shocks apply on the energy storage system.

In some embodiments, charging of the retrofitted diesel locomotive is selected from the group consisting of regenerating charging, unmanned dynamic or unmanned static charging, including any combination thereof.

In some embodiments, operation of the retrofitted diesel locomotive has zero charging down time and zero labor cost involve in charging.

In some embodiments, the kit is installed within the locomotive.

### BRIEF DESCRIPTION OF THE DRAWINGS

The presently disclosed subject matter may be more clearly understood upon reading in the following detailed description embodiments of non-limiting exemplary embodiments thereof, with reference to the drawings.

Dimensions of components and features shown in the figures are chosen for convenience or clarity of presentation and are not necessarily shown to scale. Wherever possible, the same reference numbers will be used throughout the drawings and the following description to refer to the same and like parts:

FIG. 1 presenting a scheme of a retrofitted diesel locomotive to a battery locomotive according to some embodiments of the present invention;

FIG. 2A-2B presenting a schematic view of (2A) a yard layout designed for the implementation of an energy-efficient, battery-operated locomotive system in conjunction with a supporting microgrid infrastructure, and (2B) a retrofit yard according to some embodiments of the present invention;

FIG. 3 presents a scheme presenting power sources suppling power (and connected to a mutual busbar) to overhead conductors according to some embodiments of the present invention;

FIG. 4A-4C present a perspective view of a locomotive charging infrastructure showing a rigid overhead conductor system with designated power and return current lines;

FIG. 5A-5B present how energy is transferred when charging infrastructure is (5A) empty (devoid of a battery locomotive), and occupied by an at least one battery locomotive (5B); and

FIG. 6 presents an electrical plan of the battery locomotive in a zero-emission operating system, according to some embodiments of the present invention.

### DETAILED DESCRIPTION OF THE PREFERRED EMBODIMENTS

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

According to one aspect of the present invention there is provided a method for retrofitting a diesel yard to a battery yard, the method comprising (i) retrofitting a diesel locomotive to a battery locomotive, (ii) adding a charging infrastructure, and (iii) building a renewable energy source.

In some embodiments, retrofitting a diesel locomotive to a battery locomotive comprises adding the following elements to the locomotive traction motors, battery container, at least one pantograph, at least two DC-DC converters, and a DC cabinet. In some embodiments the DC cabinet comprises or is contactors and a DC breaker. AS used herein the term “direct current (DC)” refers to unidirectional flow of electric charge, typically produced by sources such as batteries, solar cells, or DC generators. In direct current, electrons move consistently in a single direction through a conductor, as opposed to alternating current (AC), where the flow of electrons periodically reverses direction.

In some embodiments, the battery locomotive comprises at least two radars, one at locomotive front and second on back. In some embodiments, the at least one radar is configured to enable locomotive computer to evaluate locomotive distance and speed until it is couple with a railcar. In some embodiments, if needed the computer will set the locomotive to a regenerative braking status causing the locomotive to slow down immediately.

As used herein the terms “battery locomotive” and “retrofitted diesel locomotive” are used interchangeably, and refer to a diesel locomotive which was retrofitted to a battery locomotive by: (i) replacing the existing fuel source of the locomotive to a battery, (ii) replacing the diesel engine to an electric traction motor, (iii) adding (a) an at least one pantograph, (b) a DC-DC converter, (c) a direct current chamber, (d) a battery chamber. Optionally the battery locomotive further comprises a damper and an at least one radar.

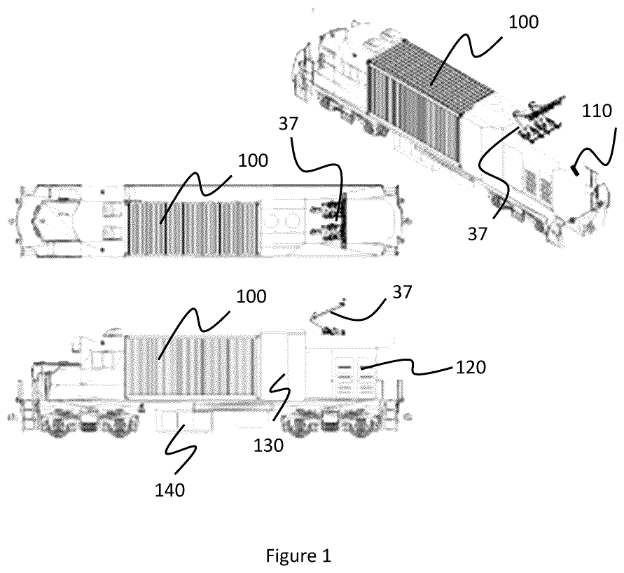

Reference is now made to FIG. 1, an illustration demonstrating a retrofitted diesel locomotive to a battery locomotive according to some embodiments of the present invention, having a radar 110 at the back of the locomotive, a dual pole pantograph 37, DC cabinet 130, electrical compressor 140, battery container 100 and a DC-DC converter and DC-AC inverters.

As used herein the term “damper” refers to a material that reduces the amplitude of vibration and the impact of sudden forces within a system. Non-limiting example include but are not limited to hydraulic dampers, tuned mass dampers, rubber bushing and mounts, viscoelastic dampers, pneumatic dampers, coil springs, leaf springs, torsion bars, gas-pressurized shock absorbers, elastomeric shock absorbers, or hydropneumatics suspension, including any combination thereof.

As used herein, the term “DC cabinet” refers to an electrical enclosure that houses components used to distribute and manage power (DC or AC supply) in a system. The DC cabinet can consist of several separate cabinets or enclosures. For example, pantograph contactors and DC breakers can be installed on the rooftop, while other contactors, DC breakers, and electrical components can be installed on board or below deck.

In some embodiment, operating a retrofitted battery locomotive incorporate multiple modes to maximize efficiency and battery life. Non-limiting examples of multiple modes include but are not limited to static charging, dynamic charging, regenerative charging, and an idle mode that allows the locomotive to supply power to Aux system but not to traction motors. In some embodiments, static and dynamic charging are unmanned.

In some embodiments, operation of the battery locomotive has zero charging down time and zero labor cost involve in charging.

In some embodiments, retrofitting a diesel locomotive further comprises adding a charging infrastructure to yard configured to charge the retrofitted diesel locomotive. In some embodiments, adding a charging infrastructure comprises building an electrification system. In some embodiments, the electrification system comprises an overhead conductor. In some embodiments, the overhead conductor is rigid. In some embodiments, the electrification system comprises two conductors a power conductor and a return current conductor. In some embodiments, the electrification system comprises solely of a power conductor while the return current uses the rail tracks to return to the power sources. In some embodiments, power supplied to the battery locomotive is AC power and it is converted to DC power onboard the locomotive using a rectifier. In some embodiments, the power supplied to the battery locomotive is DC.

In some embodiment the charging infrastructure is or comprise a third and fourth rail conductors.

In some embodiments, the overhead rigid bars are used for power transfers between power sources (including the microgrid energy storage system) and the battery locomotives, as well as between the components of the microgrids themselves. For example, for transferring power from a solar power source or a grid source to an energy storage system, or from the energy storage system to the grid. In some embodiments, the different power sources and the energy storage system are located in different locations along the charging infrastructure.

In some embodiments, renewable is or comprises solar power source. In some embodiments, solar power source is rooftop mounting, ground mounting, or any combination thereof.

As used herein, the term “train”, and “locomotive” are used interchangeably and refer in a non-limiting manner to one or several rail-connected vehicles and/or road, trail, cable, support or path-constrained vehicle, including e.g., manned or unmanned vehicle, automatic or non-autonomous vehicle, which may include railroad vehicles of the present invention, that are capable of being moved together along a guideway, such as rail tracks, a railway, a rail line, a commuter line, to transport freight and/or passengers and a freight line (any one of which may be a train that rolls, or a train that is magnetically levitated). While a train generally includes one or more locomotives to provide power for locomotion along rail tracks, trains comprising embodiments of the present invention may power along a microgrid of rail tracks without a locomotive. The terms may be used here to mean a vehicle that moves along a rail, a vehicle that moves along a guideway as in a maglev train system, or a wheeled vehicle that must follow a catenary in order to receive electric power from the catenary for powering the vehicle.

The term “train” also means single vehicle, or any plurality of such vehicles connected in tandem. Those terms also refer to a trolley car or any other kind of rail vehicle that is unconnected to other vehicles in tandem but moves along a rail or guideway, or a car in a train of cars pulled by an engine, or a vehicle of a maglev train, or a wheeled bus that must be steered so as to follow a catenary system from which it receives electric power. Such a vehicle can be connected in a train or not be connected to any other such vehicles, and can move under the force of a separate train engine vehicle pulling or pushing the vehicle, or it can move using electric power provided by an external source via a catenary system or a via a third rail (possibly in combination with a fourth rail) or it can move under forces provided by a guideway (which forces are usually magnetic, and typically springing from electromagnetic systems). The train is a part of a railroad system (also used herein as a railway network).

In some embodiments, the rail system comprises at least one of the following elements: spur tracks, tracks, platforms, stations, signaling systems, switches and crossings, yards, bridges and tunnels, catenary system, or control centers, including any combination thereof. In some embodiments, the catenary system provides electrical power to the train. In some embodiments, the spur tracks refer to a rail road track that is branched off form a main.

As used herein, the term “microgrid” refers to a small-scale, localized power system that can operate independently or in conjunction with the main electrical grid. It typically includes energy sources such as solar panels, wind turbines, or diesel generators, energy storage (like batteries), and control systems. Microgrids are designed to provide power to a specific area, such as a neighborhood, campus, or industrial facility, and can operate independently if the main grid goes down, enhancing reliability and resilience. Microgrid is a self-sufficient energy system configured to serve a load at a discrete geographic footprint. Typically, microgrid comprises an energy storage system (ESS) as a key component. The ESS plays a vital role in enhancing the stability, reliability, and efficiency of the microgrid. In some embodiments microgrid ESS is configured to provide a buffer for rapid and high-capacity charging availability. In some embodiments, buffering is by acting as an intermediary between the electric grid and the devices being charged.

As used herein, the term “load” refers to the amount of electrical power or energy consumed by devices, equipment, or systems connected to the electrical grid or a microgrid.

In some embodiments, a freight train is created by combining a locomotive and a freight car. In some embodiments, a freight train is created at a departing yard.

In some embodiments, the battery locomotive comprises a pantograph. In some embodiments, the pantograph is configured to collect current transfers from a conductor to a battery locomotive.

In some embodiments, the battery yard is for regenerative charging, unmanned dynamic charging, unmanned static charging. As used herein, the term “regenerative charging” refers to the process of recovering and storing energy that would otherwise be lost during certain activities, such as braking or decelerating, and using it to recharge a vehicle's battery.

According to one aspect of the present invention there is provided a zero-emission operating system for charging a battery locomotive comprising (i) a battery locomotive, (ii) a yard microgrid having an at least one power source, and an energy storage system (ESS), (iii) a charging infrastructure configured to charge the battery locomotive, and (iv) an energy optimization system (EOS) configured to manage and optimize energy supply to the battery locomotive.

According to one aspect of the present invention there is provided a zero-emission operating system for charging a locomotive comprising a locomotive; a yard microgrid having an at least one power source and an energy storage system (ESS), the ESS is in electrical communication with an at least one power source; a charging infrastructure configured to charge a battery locomotive, the charging infrastructure in electrical communication with the yard microgrid; and an energy optimization system configured when executed to manage and optimize energy supply to the battery locomotive.

According to one aspect of the present invention there is provided a zero-emission operating system for charging a locomotive comprising a locomotive; a yard microgrid having an at least one power source and an energy storage system (ESS); a charging infrastructure configured to charge a battery locomotive; and an energy optimization system (EOS) configured when executed to manage and optimize energy supply to the battery locomotive.

As used herein, the term “zero-emission operating system” refers to a system in transportation that operates without producing any direct emissions of greenhouse gases or other pollutants, such as carbon dioxide (CO₂), nitrogen oxides (NOₓ), or particulate matter. A zero-emission system produces no emissions during its operation, often relying on clean energy sources like electricity, hydrogen, or renewable fuels.

In some embodiments, the energy source comprises or is a solar power source, grid power source or any combination thereof. As used herein, the term “power source” refers to any system, material, or mechanism that provides energy to generate electricity, or fuel various processes. Power sources convert the energy obtained in different forms such as thermal, electrical, chemical, or mechanical, into usable energy for industries, homes, and devices. Two types of power source are commonly used today used, renewable energy sources and non-renewable energy source. Renewable energy source are energy sources that are replenished naturally and are typically more environmentally friendly because they do not emit greenhouse gases or pollutants during operation. Non-limiting examples of renewable energy sources include but are not limited to solar power, wind power, hydropower, geothermal energy, or biomass, including any combination thereof. Non-renewable energy sources do not replenish on a human timescale. Non-limiting examples for non-renewable energy sources include but are not limited to fossil fuels and nuclear energy. In some embodiments, the power source can be a dedicated power source, a nondedicated grid connection, or both.

In some embodiments, the ESS comprises a second life electric vehicle one or more batteries. As used herein, the term “second life electric vehicle batteries” refers to using batteries from electric vehicles after they have lost around 20-30% of their original capacity. These batteries can still be repurposed for other, less demanding applications, extending their useful life in what is called a “second life”.

In some embodiments, the energy optimization system (EOS) is configured to establish a yard energy configuration that minimizes the levelized cost of energy (LCOE), accounting for both capital expenditure (CAPEX) and operational expenditure (OPEX). In some embodiments, optimization comprises optimization algorithms. In some embodiments, the energy optimization system utilizes a Mixed Integer Linear Programming (MILP) model to manage energy usage effectively. Example 1 demonstrates the optimization problem defined as a mixed integer linear programing problem.

In some embodiments, the energy flow optimization model is or comprises a mixed integer model problem. A Mixed Integer Programming (MIP) problem is an optimization problem that involves both continuous and integer decision variables. MIP models are commonly used when some decisions are naturally discrete (e.g., yes/no decisions, number of items) while others can vary continuously (e.g., amounts of resources). To formulate a MIP problem, you follow the general steps of any mathematical optimization model but account for the fact that some of your variables will be constrained to take integer values. In general, steps for formulation: 1. defining the decision variables; 2. defining the objective function; 3. specifying the constrains; or any combination thereof. An example of how to use the described model is presented in Example 1.

According to another aspect of the present invention there is provided a zero-emission operating system for charging a battery locomotive comprising (i) a battery locomotive, (ii) a yard microgrid having an at least one power source selected from the group consisting of a renewable power source, a non-renewable power source, or any combination thereof, and an ESS comprising second-life electric vehicle batteries (SLEVB), (iii) a charging infrastructure configured to charge said battery locomotive, and (v) an energy optimization system configured to manage and optimize energy supply to said battery locomotive.

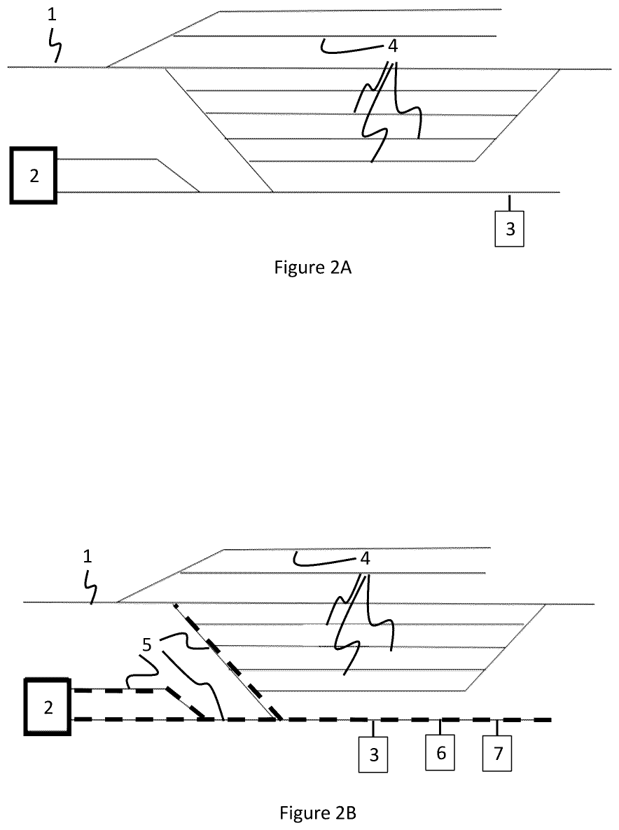

Reference is now made to FIG. 2A-2B, showing a schematic view of a yard layout designed for the implementation of an energy-efficient, battery-operated locomotive system in conjunction with a supporting microgrid infrastructure. FIG. 2A, an exemplary yard having a low scale grid connection configured to supply energy to the yard. Main line 1 interconnects with several classification tracks 4, facilitating the sorting and staging of railcars. Adjacent to the main line 2 is a workshop 2, which serves as the hub for maintenance, retrofitting activities, and housing systems relevant to the battery-electric locomotive function. The workshop 2 is also connected to a grid connection 3. Main lines 2, extends both horizontally and intersecting with the classification tracks 4, indicating zones where sorting operations occur. Charging a battery locomotive on the exemplary yard would take a long type. For example, lets assume a grid connection with a 300 KVa, and that the battery locomotive capacity is 3 Mwh, charging would theoretically take 10 hours to fully charge the battery locomotive, but practical considerations like power factor, efficiency losses, or charging speed limitations might reduce the effective power delivered. FIG. 2B is the retrofitted yard demonstrated in FIG. 2A according to some embodiments of the present invention. The yard comprises several power sources located across the yard, a solar power source 6, a grid power source 3. All power sources are connected to a mutual conductor. In some embodiments, the solar power source is or comprises a roof top mounting or a solar ground mounting, including any combination thereof. In some embodiments, the roof top mounting is located on workshop 2 roof. In some embodiments, the ground solar installation 7 is positioned adjacent to the tracks. The mutual conductor is positioned only above part of the tracks, 5 (dashed lines). The rigid overhead conductor 5 extends from workshop 2, both along the main lines 1 and across to various classification tracks 4, signifying the channels through which electricity is transmitted to the locomotives. In some embodiments, the charging infrastructure is or comprises the rigid overhead conductor. ESS 7 is installed near the ground solar installation 6. The ESS accumulates and releases power, facilitating high-capacity and rapid charging of the battery locomotives. In some embodiments the ESS is connected to the rigid overhead conductor. In some embodiments, ESS is configured to ensure energy reserve within the yard. FIG. 2B an exemplary zero-emission energy-efficient yard operation. The interconnected components, specifically the workshop 2, main line 1, classification track 4, yard grid connection 3, solar installation 6, rigid overhead conductor 5, and ESS 7, illustrate the scope of infrastructural integration required to support battery-electric locomotives and their requisite microgrid systems.

In some embodiments, the system is or comprises a retrofitted diesel yard to a battery yard. In some embodiments, the system is configured to protect the ESS and electrical equipment from a locomotive-rail car shock.

In some embodiments, the zero-emission operating system comprise a return rail current. In some embodiments, the zero-emission operating system comprises a rigid overhead conductor configured to return current. In some embodiments, the system of the present invention enables fast charging of the battery locomotive, or obtaining the lowest levelized cost of energy, including any combination thereof. In some embodiments, the battery locomotive is a retrofitted diesel locomotive.

Non-limiting examples of renewable energy sources include but are not limited to solar power, wind power, hydropower, geothermal energy, or biomass, including any combination thereof. In some embodiments, the renewable energy source comprises or is solar power. In some embodiments, the solar power source is or comprises a roof top mounting or a solar ground mounting, including any combination thereof.

In some embodiments, the at least one power source is connected to a mutual conductor. In some embodiments, the conductor is or comprises an overhead conductor. In some embodiments, the overhead conductor comprises two rigid overhead conductors, the first is configured to power and the later for return current.

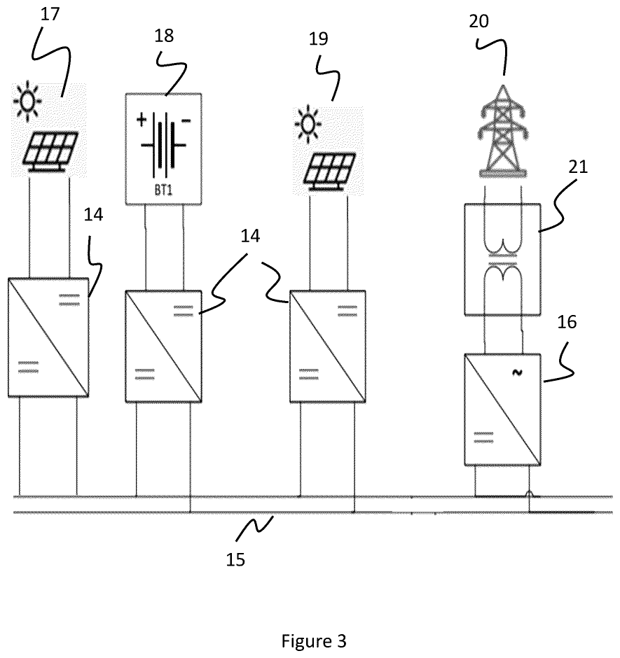

Reference is now made to FIG. 3, illustrating a schematic diagram of an energy distribution illustrating various components involved in the energy management and supply process, according to some embodiments of the present invention. Four different power sources are connected to a rigid overhead conductor in one location or far away from each other.

A rigid overhead conductor is connected to four power sources: (i) rooftop solar power mounting 17 connected to an inverter 14, (ii) ESS 18, configured to store electrical energy generated by solar power or other energy sources, ensuring the yard has reliable energy reserve, (iii) solar farm 19 (also referred herein as solar ground power) connected to an inverter 14, and (iv) grid power source 20 power source which is transferred throw a transformer and a rectifier. All four power supplies are connected to power conductor 15, and contribute to the overall energy accessible in the system. Power conductor 15, is the main conduit for electricity distribution within the yard. Power conductor 15 is a part of the charging infrastructure. In some embodiments, the charging infrastructure is configured to charge a battery locomotive according to some embodiments, of the invention. In some embodiments charging is selected from the group consisting of unmanned static charging, unmanned dynamic charging, or regenerated charging, including any combination thereof.

As used herein, the term “inverter” converts direct current generated by solar power or batteries to a desired and useable AC electrical current. A “transformer” refers to a device that transforms electrical energy between two circuits through electromagnetic induction. Transformers are commonly used to change the voltage level of alternating current (AC) electrical power. A “rectifier” refers to a device that converts AC into direct current DC.

FIG. 3 is an exemplar according to some embodiments of the present invention of an integrated approach for energy management in a yard, featuring diverse renewable energy sources, an energy storage system, and essential components for converting and distributing electricity efficiently. This setup ensures a reliable and sustainable energy supply for the yard's operational needs.

In some embodiments, the charging infrastructure is configured to charge the battery locomotive. In some embodiments, charging comprises or is regenerative charging, unmanned static charging, or unmanned dynamic charging including any combination thereof. In some embodiments, the charging infrastructure comprises a conductor. In some embodiments, the charging infrastructure comprises a rigid overhead conductor.

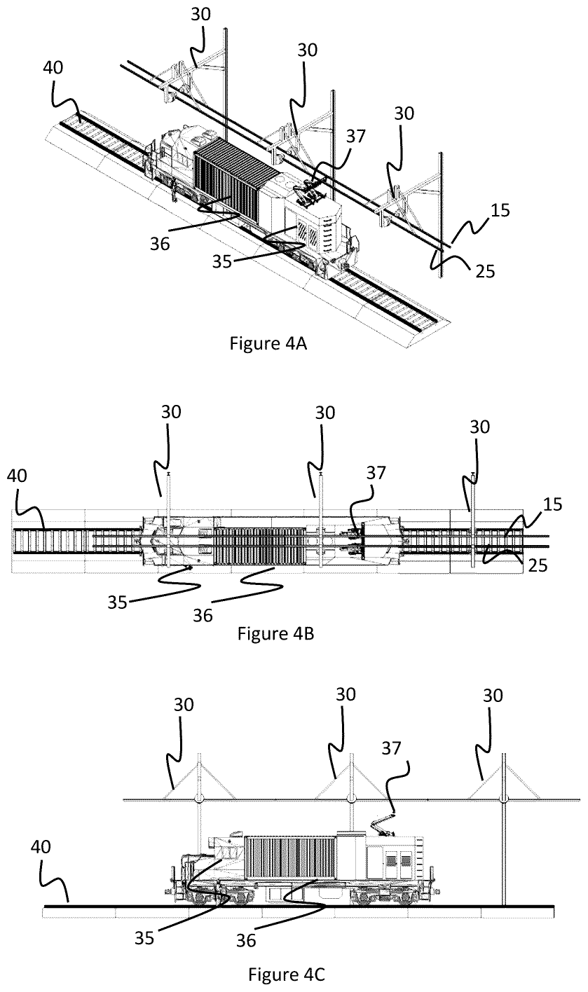

Reference is now made to FIGS. 4A-4C present a perspective view of a locomotive charging infrastructure showing overhead electrification system (30) comprising two conductors (15 and 25), one with designated power 15 and the other with return current 15. Battery locomotive 35 is position on track 40. Battery locomotive is charged using overhead electrification system 40 which supplies electricity to battery locomotive 35 using a pantograph 37 located on top of battery locomotive 35. In some embodiments, pantograph 37 is a dual pantograph. The battery locomotive comprises a battery 36 configured to receive electrical energy from the overhead electrification system (30) and store the energy. Charging can occur while the locomotive is either stationary or in motion. The charging infrastructure supports various charging modes. In some embodiments, the charging modes are selected from the group consisting of dynamic charging, static charging or regenerative charging, including any combination thereof. In some embodiments, the overhead electrification system comprises solely one conductor, a power conductor, and return current is done through rail tracks. According to some embodiments of the present invention, the illustration of FIGS. 3A-3C demonstrates how the described elements work together to enable a robust and versatile electric railway system, facilitating the reduction of emissions and energy consumption in rail operation.

In some embodiments a battery locomotive a battery, an electrical motor, a power managements system, comprises a convertor/inverter, auxiliary system or a control system, including any combination thereof. In some embodiments the battery is configured to store energy and supply energy to power the locomotive's electrical motor and locomotive load. In some embodiments, non-limiting example of locomotive load include but are not limited to traction motors, inverter, converter, dynamic/regenerative braking system, onboard control systems, lighting system, cooling system, air compressors, heating, ventilation, air conditioning, battery charging system, or monitoring systems, including any combination thereof.

In some embodiments, the battery locomotive comprises a pantograph configured to collect current transferred from the conductor, thus enabling power to flow from at least one power source to the battery locomotive. In some embodiments, the pantograph is a DC pantograph comprising two poles, a return current pole and a power pole. A person skilled in the art would appreciate that if the return current is conducted by an existing rail track, the pantograph comprises one pole, a power pole, configured to transfer electric energy from the overhead conductor to the battery of the battery locomotive.

As used herein the terms “locomotive” and “battery locomotive” are used interchangeably and refer to a locomotive powered by an electricity stored on-board batteries, rather than by traditional fuels like diesel or coal or by drawing power from overhead lines or a third rail. Electrical power is transferred from the power conductor 15 to battery 36 and other electrical systems within the locomotive 35. Return current conductor 25 ensures efficient and safe return of electrical current. In some embodiments, return current conductor 25 mitigates interference with track signaling

In some embodiments, energy the battery locomotive receives (i) flows to the locomotive load, and (ii) to the battery.

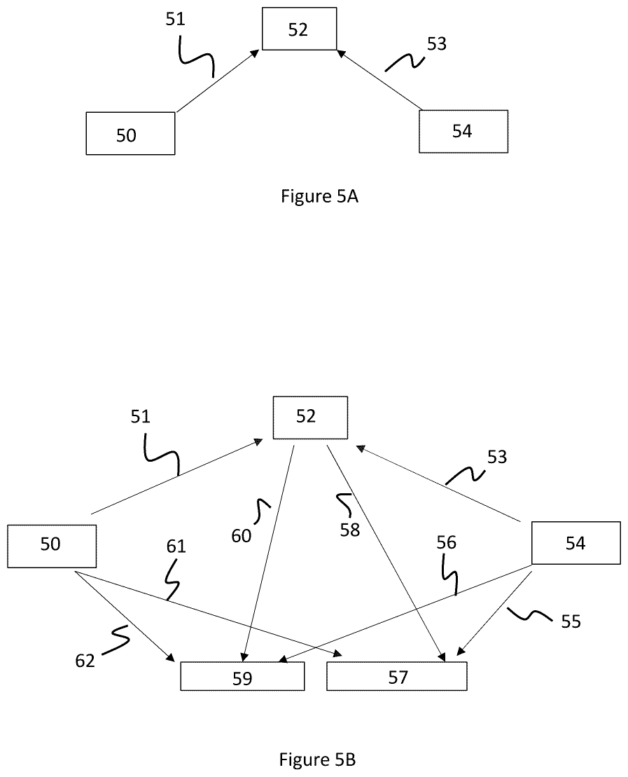

Reference is now made to FIG. 5A-5B demonstrating how energy is transferred when the charging infrastructure is (FIG. 5A) empty (devoid of a battery locomotive), and is occupied by an at least one battery locomotive (FIG. 5B).

FIG. 5A showing how electrical energy flows (51) from a photovoltaic element 50 (solar power source) to ESS 52, and how electrical energy flows (53) from a grid 54 to ESS 52. ESS is configured to receive and store energy obtained from a photovoltaic or a grid, including any combination thereof.

FIG. 5B demonstrating electrical energy flow in the presence of a locomotive in the charging infrastructure. In addition to the energy flow presented in FIG. 4A, electric energy transfers from photovoltaic element 50 to locomotive energy storage system 59 and to locomotive load 57, flow 62 and 61, respectively. Furthermore, grid power source 54 transfers electric energy to locomotive energy storage system 59 and to locomotive load 57, flow 56 and 55, respectively. In addition, ESS 52 transfers electric energy to locomotive energy storage system 59 and to locomotive load 57, flow 60 and 58, respectively. In some embodiments, the system of the present invention ensures efficient energy distribution and utilization, promoting consistent locomotive functionality and operational reliability even under varying conditions.

In some embodiments, the charging of a battery locomotive using the system of the present invention depends solely on ESS energy capacity and its charging and discharging rate, also known as c rate.

In some embodiments, the charging of a battery locomotive using the system of the present invention devoid of grid power dependency. For example, let assume ESS capacity in a exemplary yard according to some embodiments of the present invention is 6 mwh and an existing grid connection equals 0.3 mw (300 kw), total power availability will be 3.3 mw, having a c rate of 0.5, as many LFP ESS have.

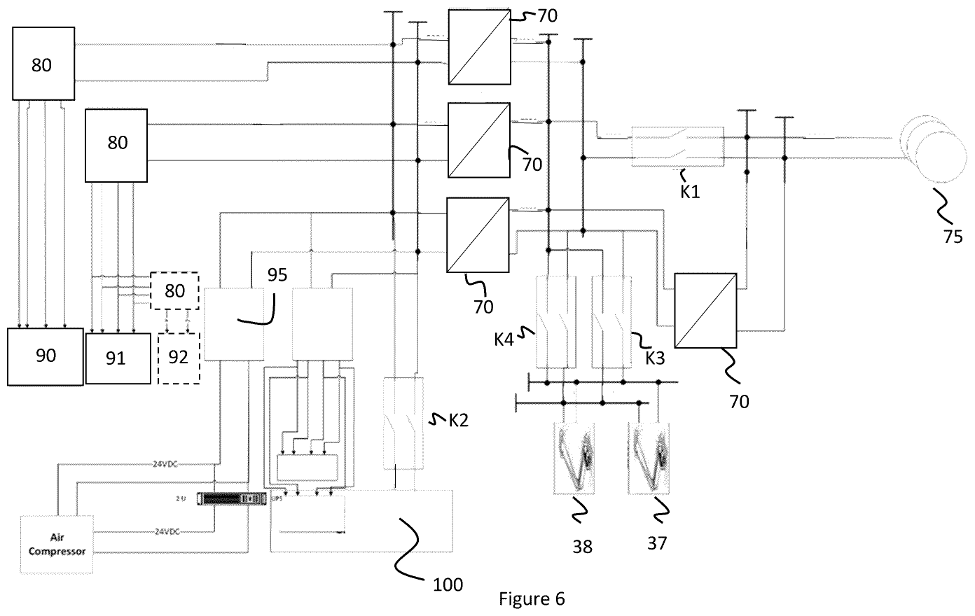

Reference is now made to FIG. 6 an illustration demonstrating an example of an electrical plan of the battery locomotive in a zero-emission operating system, according to some embodiments of the present invention. Pantographs 37 and 38 are configured to receive energy from overhead conductor 15 (not seen in figure) and return current to overhead conductor 25 (not shown in figure). The electricity received is then transferred from pantographs 37 and 38 to locomotive load, locomotive traction motors 75, or locomotive ESS 59, including any combination thereof. The electric current flows pantograph 37, or pantograph 38, including any combination thereof, through a DC convertor 70 before it reaches traction motors 75. The electric current used for the locomotive load passes through a DC convertor 70 and a AC inverter 80. The locomotive load comprises air compressor 90, blower 91, optionally the system further comprises an addition load 92 which requires an additional inverter 80. or locomotive ESS 59, including any combination thereof. The electrical flow is controlled by contactors K1-K4. An example on how a contactor is controlled is seen in Example 2. Battery 100 is discharged as long as charging infrastructure is devoid of a battery locomotive. The DC-DC convertor 95 is configured to adjust voltage supplied to the motors according to notch that the locomotive is in. As used herein, the term “notch” refers a discrete power setting in a locomotive's throttle system, particularly in diesel-electric locomotives, where the throttle has several notches, typically 8, that determine the amount of power the diesel engine provides to the traction motors. A person skilled in the art would appreciate that the traction motors in a locomotive are designed to handle varying amounts of current, and their torque output is proportional to the electrical power they receive. The notch settings gives the engineer precise control over how much power is sent to the motors, allowing for efficient train operation.

In some embodiments, the power from the pantographs 37 and 38 can switch its poles depending on the locomotive orientation. In some embodiments, this is controlled using contactors K3 and K4, when K3 is open and K4 is closed, charging occurs when the locomotive front faces one direction, and when K4 is closed and K4 is opened, charging occurs when the locomotive front faces the other direction. For example, if one direction is east the other direction is west.

In some embodiments, dynamic charging occurs when K1 and K2 are closed and when converter internal contactor is closed. Static charging occurs when K1 and K2 are closed and when converter internal contactor is open. Regenerative charging occurs when K1 and K2 are closed and when converter is open. In some embodiments, dynamic and static charging are unmanned.

In some embodiments, energy transfers to the locomotive solely when the locomotive is under the overhead conductor.

In some embodiments, the zero-emission operating system of the present invention enables fast charging and dynamic unmanned charging, enabling 24/7 operation devoid of charging downtime.

According to another aspect of the present invention, there is provided a locomotive retrofit system comprising: a battery configured to replace an existing fuel source of a locomotive, an electric traction motor configured to replace an existing diesel engine, and means for interfacing the electric traction motor with a pre-existing drive train of the locomotive, wherein the retrofit system is configured to ensure compatibility and optimized performance for battery operation.

In some embodiments, the system further comprising a damper configured to protect the battery from vibrations and shocks.

In some embodiments, the system further comprising a radar system and/or an ultrasonic sensor configured to aid in locomotive coupling processes by detecting obstacles and automatically applying brakes.

According to another object of the invention there is provided a locomotive retrofitting kit comprising: a battery configured to replace an existing fuel source of a locomotive; an electric traction motor configured to replace an existing diesel engine; an at least one pantograph; a direct current-direct current converter; a direct current chamber; a battery chamber; and a compressor; wherein the retrofit kit is configured to ensure compatibility with a locomotive to be retrofitted and configured for optimized performance for battery operation.

In some embodiments, the locomotive retrofit kit further comprising a damper configured to protect the battery pack from vibrations and shocks.

In some embodiments, further comprising an at least one radar system configured to aid in reducing locomotive coupling shocks apply on the energy storage system.

In some embodiments, the kit is installed within the locomotive.

In some embodiments, charging of the retrofitted diesel locomotive is selected from the group consisting of regenerating charging, unmanned dynamic or unmanned static charging, including any combination thereof.

In some embodiments, operation of the retrofitted diesel locomotive has zero charging down time and zero labor cost involve in charging.

Reference is now made to FIG. 1, showing the elements the kit comprise, electric traction motor, two pantographs, DC-DC converter, DC-chamber, a battery chamber, and a compressor.

According to another aspect of the present invention there is provided, a method for operating a battery-powered locomotive comprising: retrofitting a locomotive with a battery system, replacing an existing diesel engine with an electric traction motor, interfacing the electric traction motor with a pre-existing drive train, and configuring the locomotive to operate in various modes including static charging, dynamic charging, regenerative charging, and idle management mode.

In some embodiments, battery system comprises radar system and/or an ultrasonic sensor, a damper, a battery configured to replace an existing fuel source of a locomotive, an at least one pantograph, a direct current-direct current converter, a direct current chamber, or a battery chamber, including any combination thereof.

In some embodiments, a management mode is configured to allow the locomotive to enter a low-power state when not actively engaged in yard operations

According to another aspect of the present invention there is provided, a microgrid energy optimization system for a locomotive yard comprising an optimization model configured to minimize the levelized cost of energy (LCOE) for yard operations; a mixed integer linear programming (MILP) formulation for evaluating multiple configurations of yard energy usage; and an algorithm leveraging off-the-shelf solvers to determine a configuration that yields the lowest LCOE, considering the variability of renewable energy sources.

In some embodiments, the optimization model accounts for capital expenditure (CAPEX) and operational expenditure (OPEX).

### Example 1

### Minimum Levelized Energy Cost

The optimization problem is defined as a mixed integer linear programing problem. A person skilled in the art would appreciate that a mixed integer problem comprises four parts, an objective function, decision, constrains of the system and databases that the model can use.

Non limiting examples of MILP solvers include but are not limited to Gurobi, CPLEX, solving constraint integer programs (SCIP), GNU linear programming kit (GLPK), MOSEK, Coin- or branch and cut (CBC), baron, FICO Xpress (Xpress), AMPL, Pyomo, or JUMP, including any combination thereof.

Objective function: minimize the cost of energy over the model period, for example 20 years, can be represented by the following equation:

$$Investment + ( {\sum }_{T = 1}^{I = N} \frac{1}{{( 1 + R )}^{l}} ) * ( gridcost + maintenance cost ) ,$$

wherein R is time discount factor and N is the cost of energy over N years, for example 20.

The investment is represented by the following equation:

$$Investment = photovoltaic capacity \times photovoltaic energy cost + ESS capacity \times ESS energy cost + overhead conductor length \times overhead conductor price .$$

Sum of the investment in photovoltaic installation, energy storage system, charging infrastructure.

The grid cost is represented by the following equation:

$$gridcost = \sum ( grid\_locoiload ( t ) + grid\_locoiess ( t ) + grid\_ess ( t ) ) * ( gridprice ( t ) )$$

The equation represents the amount of energy transferred from the grid multiply the grid price at any given time. Energy from the grid can transfer from the grid to the locomotive energy storage system, locomotive load or grid energy storage system, including any combination thereof.

The maintenance cost is presented by the following equation

$$Maintenance cost = K 1 \times photovoltaic capacity + K 2 \times ESS capacity$$

Photovoltaic capacity represents how much photovoltaic should be installed in the system.

ESS capacity represents how much ESS should be installed in the system.

The photovoltaic capacity and ESS capacity are decision variables.

Define decision variable, these variables represent controllable features or decidable features, power flow with in a microgrid at time (t) (FIG. 5B) is also decision variable. The power flow can be controlled by using contactors and DC-DC converters.

Define constrains, the constrains represent limitation and/or rules that govern the problem, for example energy storage is constrained between a minimum value and a maximum value dictated by the energy storage technology used, or ESS discharging/charging rate. As used herein, the term “constrain” refers to a rule or limitation that govern the problem.

Another constraint is that the locomotive ESS state of charge is higher than a define minimum at all time, this constrain means the locomotive has energy for its needs at all time.

### Constrains:

State of charge of the stationary ESS represented by the following equation:

$$Ess\_soc ( t ) = Ess\_soc ( t - 1 ) + pv\_ess ( t ) + grid\_ess ( t ) - ess\_locoi \_load ( t ) + ess\_locoiess ( t ) .$$

Charging conductor capacity limit represented by the following equation:

$$Pv\_locoi \_load ( t ) + pv\_loci \_ess ( t ) + ess\_locoiess ( t ) + ess\_locoi \_load + grid\_locoiload ( t ) + grid\_locoi \_ess <= charging\_cap .$$

State of charge of locomotive ESS represented by the following equation:

$$locoiEss\_soc ( t ) = locoiEss\_soc ( i - 1 ) + pv\_locoi \_ess ( t ) + grid\_locoiess ( t ) + ess\_locoiess ( t ) .$$

If locomotive i is not under the overhead conductor energy is not transferred to the locomotive

$$Ess\_locoiload ( t ) = ess\_locoi \_load ( t ) * locomotive\_location ( t ) ; and$$

$$Ess\_locoi \_ess ( t ) = ess\_locoi \_load ( t ) * locomotive\_location ( t ) .$$

The same constrains apply to power transferred from the grid and the photovoltaic.
ess_soc (t)<ess_cap; all ESS has max capacity; and
ess_soc (t)>ess_min; all ESS need to be with at least min energy at all time

The energy flow at a given microgrid is represented by:
grid_locoi_load (t), presenting the energy flow from a grid to locomotive i, at time t, where i is an integer;
grid_locoi_ess (t), presenting the energy flow from a grid to locomotive i ESS, at time t, where i is an integer;
grid_ess (t), presenting energy flow from grid to the stationary ESS, at time t;
pv_ess (t), presenting energy flow from photovoltaic to the stationary ESS, at time t;
pv_locoi_ess (t), presenting energy flow from photovoltaic to locomotive i ESS, at time t;
Ess_locoi_ess (t), presenting energy flow from ESS to locomotive i ESS, at time t; and
Ess_loco i_load (t), presenting energy flow from ESS to locomotive i load, at time t;
wherein t is a time unit chosen, for examples minutes, hours, or any other desired time.

### Model Databases

Pv_genration (t)—pv generation at time t for every 1 kwp of installed solar panels;
Location i(t)—equal to 1 if locomotive i is under the charging conductor and 0 if not;
grid_price (t)—price of grid power at time t;
grid_cap—max power that can purchased from the grid (grid connection);
Ess_min—the minimum state of charge for the ESS;
Locomotivei_ess—ESS capacity of locomotive I;
Loss factor—how much power is lost when charging/discharging the ESS; and
Charging-cap—max power that can be transferred via the overhead conductor.

The outcome of the model is the decision var of the model.

Different charging position and length alternative can be set for the model to explore the lowest LOCE alternative.

The day-to-day operation of the yard energy system, after constructing the yard microgrid, will be based on an optimization model for the next day or any other chosen period (other than one day). The objective function of the model is to minimize the cost of grid power purchased in the future period, for example, the next day. The decision variables are the energy flow in the microgrid at a specific time (t). The unit of time can be a second or a minute in the future period.

### Example 2

An example of contactors K1-K4 status and how there switching enables the locomotive to perform at various state of operation. A computer can control the contactor switcher position and thus affecting the why a locomotive is charged and perform. The switchers position depended on locomotive direction, if need the switches position is changed in order to switch the direction power is transferred and current is returned. The switchers position depended on the way the battery locomotive is charged, in static charging contactor K1 and contactor K2 are closed, while contactor DC convertor 70 is open. In dynamic charging contactor K1 and contactor K2 are closed, while contactor DC convertor 70 is closed. In some embodiments in dynamic charging and operating occurs simultaneously. Different contactor are closed an open depending on where the electricity is transferred, for example for the locomotive to operate on the electric energy stored in the locomotive battery, K2 conductor has to be closed, and if the locomotive is still in the yard K3 and K4 are open. The computer controls which conductor is open and which is close in order to operate the system. In some embodiments, the computer ensures that efficient charging occurs, optimized energy consumption is obtained, or a optimized levelized cost of energy is obtained, including any combination thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments pertaining to the invention are specifically embraced by the present invention and are disclosed herein just as if each and every combination was individually and explicitly disclosed. In addition, all sub-combinations of the various embodiments and elements thereof are also specifically embraced by the present invention and are disclosed herein just as if each and every such sub-combination was individually and explicitly disclosed herein.

Additional objects, advantages, and novel features of the present invention will become apparent to one ordinarily skilled in the art upon examination.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What we claimed is:

1. A zero-emission operating system for charging a locomotive comprising
a yard microgrid having
an at least one power source and
an energy storage system (ESS), in electrical communication with said
at least one power source;
a charging infrastructure configured to charge a battery locomotive; said
charging infrastructure in electrical communication with said yard microgrid;
and
an energy optimization system (EOS) configured when executed to manage and optimize energy supply to said battery locomotive.

2. The system of claim 1, wherein said battery locomotive comprises an at least pantograph.

3. The system of claim 1, wherein said charging infrastructure comprises an at least one conductor.

4. The system of claim 3, wherein said conductor comprises an overhead conductor, a third rail conductor, or any combination thereof.

5. The system of claim 1, wherein operation of said battery locomotive has zero charging down time and zero labor cost involve in charging.

6. The system of claim 1, wherein said charging is selected from the group consisting of regenerating charging, unmanned dynamic or unmanned static charging, including any combination thereof.

7. The system of claim 1, wherein energy storage system of said battery locomotive comprises electrical energy at any given time.

8. The system of claim 1, wherein said energy optimization comprises an optimization model for minimizing the levelized cost of energy (LCOE) for yard operations; a mixed integer linear programming (MILP) formulation for evaluating multiple configurations of yard energy usage; and
wherein said energy optimization is configured to yield the lowest LCOE while taking in consideration variability of renewable energy sources.

9. A locomotive retrofitting kit comprising:
a battery configured to replace an existing fuel source of a locomotive;
an electric traction motor configured to replace an existing diesel engine;
an at least one pantograph;
a direct current-direct current converter;
a direct current chamber;
a battery chamber; and
a compressor;
wherein said retrofit kit is configured to ensure compatibility with a locomotive to be retrofitted and configured for optimized performance for battery operation.

10. The locomotive retrofit kit of claim 9, further comprising a damper configured to protect said battery pack from vibrations and shocks.

11. The locomotive retrofit kit of claim 9, further comprising an at least one radar system configured to aid in reducing locomotive coupling shocks apply on the energy storage system.

12. The locomotive retrofit kit of claim 9, wherein said kit is installed within said locomotive.

13. The locomotive retrofit kit of claim 9, wherein charging of said retrofitted diesel locomotive is selected from the group consisting of regenerating charging, unmanned dynamic or unmanned static charging, including any combination thereof.

14. The locomotive retrofit kit of claim 9, wherein operation of said retrofitted diesel locomotive has zero charging down time and zero labor cost involve in charging.

15. A method for retrofitting a diesel yard to a battery yard comprising steps of adding a charging infrastructure; and
providing a renewable energy source;
wherein said renewable energy source and said charging infrastructure are configured to charge a battery locomotive.

16. The method of claim 15, wherein said retrofitting said diesel locomotive comprises replacing an existing fuel source of said diesel locomotive with a battery;
replacing a diesel engine with an electric traction; and
adding to said diesel locomotive
an at least one pantograph;
a direct current-direct current converter,
a direct current chamber; and
a battery chamber.

17. The method of claim 15, wherein said charging infrastructure comprises an at least one overhead conductor.

18. The method of claim 15, wherein operation of said retrofitted diesel locomotive has zero charging down time and zero labor cost involve in charging.

19. The method of claim 15, wherein charging of said retrofitted diesel locomotive is selected from the group consisting of regenerating charging, unmanned dynamic or unmanned static charging, including any combination thereof.
